(19) United States
(12) Patent Application Publication
(10) Pub. No.: US 2015/0226597 A1
(43) Pub. Date: Aug. 13, 2015

(54) Method, System and Apparatus for Convenience and Compliance with Environmental Protection Regulations and Occupational Safety Standards during On-Site Fluid Flow Meter Calibration and Verification Procedures

(71) Applicant: Ms. Jennifer Claire Rundle, (US)

(72) Inventor: Craig Joseph Gaspard, JR., Baton Rouge, LA (US)

(21) Appl. No.: 14/179,530

(22) Filed: Feb. 12, 2014

(51) Int. Cl. G01F 25/00

(52) U.S. Cl. CPC G01F 25/0007

(57) ABSTRACT

The present invention offers a useful, novel, and non-obvious means of safely and quickly verifying and calibrating fluid flow instrumentation responsible for the accurate measurement and reporting of various forms of fluid flow rates, including but not limited to the verification and calibration of the fluid flow instrumentation responsible for the measurement and reporting of greenhouse gas emission rates.

The present invention introduces major modifications into the field of fluid flow meter calibration and verification and into the field of on-site use of standardized Coriolis flow meters as reference meters (also called “Master Meters”) under procedures such as those set out in the International Organization for Standardization (ISO) Standard No. 10790:1999 (E), for fluid flow meter calibration and verification.

The present invention introduces to the field a portable, self-contained system for on-site (field) fluid flow meter calibration and/or verification and eliminates many demands for resources typically placed on manufacturing facilities during fluid flow meter calibration and verification procedures.

The present invention includes provision for the convenient and environmentally responsible disposal of contaminated and/or potentially hazardous waste material at authorized locations and thereby creates an atmosphere of enhanced occupational safety for the manufacturing facility requesting on-site fluid flow meter calibrations.

### FIELD OF THE INVENTION

This invention addresses the need to verify and accurately calibrate fluid flow meters in a convenient, efficient, safe, cost-effective and environmentally friendly manner.

Because of their ability to measure mass flow and to calculate volumetric flow, Coriolis flow meters are currently used as standard Master Meters during typical on-site and off-site verification and calibration of fluid flow meters. Procedures such as those outlined in the International Organization for Standardization (ISO) Standard No. 10790:1999 (E) are currently employed to ensure accuracy and precision during normal verification and calibration processes.

One impact of this invention on the field is that manufacturing facilities currently compelled to ship fluid flow meters off-site for calibration and verification will have better, more cost-effective options and will no longer be forced to incur the costs, risks and decreased productivity associated with off-site shipping.

Under the provisions of this invention, calibrating experts who arrive on-site will no longer demand from manufacturing facilities valuable resources such as time, attention, special permissions during setup, supplies of clean water and electrical power, or involvement in the disposal of contaminated waste.

Increases in productivity due to convenient and safe on-site calibration techniques, in addition to the reduced costs and risks associated with this method of flow meter calibration, may in turn be passed down to the consumer in the form of lower prices.

Additionally, risks associated with cross-contamination among flow meters during the calibration process are minimized and, in turn, every plant using the current invention benefits from easily enhanced product quality control.

Communities surrounding manufacturing facilities may quickly benefit from the adoption of this invention, as local manufacturing facilities are presented with viable alternatives to their current, compromised practices for the disposal of potentially contaminated water following fluid flow meter verification and calibration.

### BACKGROUND OF THE INVENTION

### Fluid Flow Meter Calibration: Global Significance

All over the world, millions of people enjoy cold soft drinks, purchase petroleum products for vehicles, and rely on perfectly constructed PVC pipelines for removal of everyday waste material. Very few people, however, think about the crucial behind-the-scenes processes at manufacturing facilities where fluid flow rates inside fluid flow meters must be measured precisely so that soft drinks taste just right, gasoline is of the highest quality, and underground pipes are strong enough to resist deterioration for decades.

Manufacturing facilities, chemical plants and other industries using fluid flow meters require that certain flow meters be regularly verified and/or calibrated for the sake of quality control. Additionally, 40 CFR Part 98.244 and 98.3 (Title 40 of the United States Code of Federal Regulations, Part 98.244 and Part 98.3) outline not only the requirements for mandatory annual greenhouse gas emissions reporting but also fluid flow meter calibration accuracy requirements, stating, “The owner or operator of a facility or supplier that is subject to the requirements of this part must meet the applicable flow meter calibration and accuracy requirements . . . ” (Part 98.3 (i)(1)-(7)

Fluid flow meters are the primary instrument used to measure liquid and gas flow rates. Volumes and masses of greenhouse gases, mandated for annual report under 40 CFR Part 98.244, prove difficult to measure once released into the atmosphere. Calculations pertaining to environmental emissions are, therefore, based primarily on the volumes and masses of fuels consumed by an industry.

These volumes and masses of fuels being consumed are the very data of fluid flow meters.

It doesn't take long to realize how the United States Government, manufacturing industries and individual consumers alike must be assured that fluid flow meters are calibrated reliably and on a regular basis and that the accuracy of data coming from fluid flow meters is verified according to industry standards.

### Existing Methods for Fluid Flow Meter Calibration and Verification

Currently, fluid flow meters are calibrated and verified using methods and means that are in many ways unsafe, inconvenient, inefficient, sloppy, time-consuming, costly and hazardous to the environment. These inefficient, costly and hazardous methods shall herein be called “Existing Methods.”

Existing Methods for fluid flow meter calibration employ industry-standardized calibration equipment such as Master Meters, traceable to standards held by the National Institute of Standards and Technology (NIST), in conjunction with careful procedures such as those outlined in the International Organization for Standardization (ISO) Standard No. 10790:1999 (E). Such procedures are used while calibrating a “Unit Under Test” (UUT)—the meter in use at any facility—against a previously standardized Master Meter.

The present invention employs Coriolis Master Meter systems and arrangements such as those described in U.S. Pat. No. 4,252,028 and makes use of traditional methods and procedures for fluid flow meter calibration such as those outlined in U.S. Pat. No. 476,095.

The present invention, however, seeks to improve on methods currently used for the verification and calibration of fluid flow meters and seeks to reduce both the risks and the costs associated with fluid flow meter calibration and verification procedures.

### Existing Methods: The Cost of Decreased Productivity

The most common Existing Method for verification and calibration of fluid flow meters in the United States has been the practice of disengaging the existing fluid flow meter from its position in the plant's manufacturing process and sending the flow meter to a well trusted calibration facility such as the facilities found in Texas, Colorado or Indiana. This off-site calibration process—including disengagement of the meter from its position in the line of production, packaging the meter to be shipped, shipping of the flow meter to a calibration facility, handling of the meter by non-company personnel, calibration of the meter, return shipping of the meter, and re-engagement of the meter into the line of production—often takes several weeks.

During this time, the otherwise fully functional flow meter is removed from the plant's normal line of production. When production is halted at a manufacturing facility for any reason, costs rise and the company's competition gains an advantage. Manufacturing facilities may be able to compensate for the “down time” of disengaged fluid flow meters by purchasing and employing temporary replacement meters. However, fluid flow meters are expensive instruments that are most cost-effective when engaged in production year-round. A substitute fluid flow meter, used only during the annual calibration cycle of a primary flow meter, might be considered a financial liability to a manufacturing facility and is not well maintained by sitting for months of the year on a shelf.

The internal workings of a fluid flow meter include delicate and very sensitive components. Over time and with normal use, mechanical stress and wear, erosion, and product build-up can compromise the sensitive internal components of a fluid flow meter and cause the flow meter to require re-calibration.

The irony lies in the fact that the shipping process, in and of itself, causes additional mechanical stress on these sensitive internal components of flow meters. The “rough and tumble” of boxes transferred from truck to conveyor belt to truck often translates into a series of jolts inside the meter. One good bounce or fall inside a truck can void a meter's calibration altogether.

In turn, a meter that's just been shipped off-site for calibration may arrive back on-site with lower levels of accuracy than it had before calibration. The plant or facility may all-the-while assume that the recent calibration guarantees a meter's accuracy as it measures fluid flow rates. With no way for the facility to ascertain whether the meter has encountered abuse during shipping, the facility, having merely complied with 40 CFR Part 98.3 (i)(1)-(7) and other regulations, may unknowingly introduce a compromised meter back into the line of production.

For these reasons, meters that have been shipped off-site for calibration might well be considered by manufacturing facilities and government officials as loosely calibrated and certainly unverified.

Additionally, when shipped off-site, $30,000-$100,000 fluid flow meters have been lost in transit both to and from flow meter calibration facilities. As long as the flow meter is “away from home,” whether in the hands of a shipping company or being handled by a calibration facility, the flow meter is not under the care of the company ultimately responsible for its upkeep and for its number of days in use. Shipping flow meters to off-site calibration facilities, therefore, can pose threats not only to the safety of the meters themselves but also to the manufacturing company's bottom line.

Existing Methods: Concerns about Occupational Safety

A second Existing Method for flow meter calibration involves the on-site calibration of fluid flow meters. While the benefits of on-site flow meter calibration are easy to imagine, Existing Methods for on-site calibration often require 3 to 6 hours of set-up time and create scenarios inconvenient and potentially unsafe not only for the calibrating expert but also for the manufacturing facility itself.

Before an expert brings potentially spark-producing calibration equipment into the plant's process areas and before calibration equipment is connected to the plant's existing power receptacles, plant operations personnel typically test the area for explosive gases and certify to the visiting expert that it is safe to run computer equipment and other potentially spark-producing equipment in that immediate area. Operations personnel present to the calibrating expert a “Hot Work Permit” and the calibration expert is then cleared to safely begin work.

Existing Methods for in-site flow meter calibration show both the calibrating expert and the calibration equipment as approaching and working closely in the vicinity of the plant's line of production.

Under Existing Methods, the calibrating expert's potentially spark-producing equipment is brought into areas surrounded by petroleum products and many other flammable liquids and gases found on-site at chemical refineries, tanker vehicles, fluid reservoirs and various lines of production. The field of fluid flow meter calibration is in need of a system and method for on-site fluid flow meter calibration without any occupational risks associated with the exposure of sparks to explosive gases.

And finally, on-the-job injuries often result in decreased productivity, higher workers' compensation insurance premiums, and greater risks of litigation. Although injuries to the spine are among the most common work-related injuries, it is commonly expected that plant personnel and calibrating experts alike be able to hoist fluid flow meters into position by hand. Existing Methods offer no solution to the difficult problem of lifting the fluid flow meters, often weighing up to 200 pounds, into position on the calibrating technician's coupling adapter prior to calibration. Existing Methods for fluid flow meter calibration, therefore, force employers and employees alike to assume a high level of unnecessary risk.

### Existing Methods: Inconvenience and Limits on Electrical Power

Larger flow meters require greater flow rates during the calibration process, and these greater flow rates require greater electrical current. Generally, while calibration of 2-inch flow meters may be accomplished using standard electrical outlets, calibration of flow meters with diameters larger than 2 inches, when coupled with existing water-pump technology, requires more electrical current than that provided by the typical electrical outlet. It is not uncommon for sufficient electrical current to be inaccessible in a normal manufacturing facility.

Even when sufficient electrical current can be made available, outlets providing such specialized power supplies are rare and may be located inconveniently far from some or all of the fluid flow meters in need of calibration.

Under Existing Methods, therefore, accurate calibration of larger flow meters is often impeded by limited electrical current and voltage when calibrations of larger meters are performed on-site at typical manufacturing facilities and chemical refineries.

And finally, even calibrations of smaller, 2-inch flow meters from standard electrical outlets have been known to “trip” a facility's own power breakers, resulting in unexpected and costly interruptions surrounding the particular flow meter unit under test.

This minimum electrical current requirement, therefore, often translates into a series of costly inconveniences, all at the expense of the manufacturing facility.

Existing Methods: Quality Control and Concerns of Cross-Contamination

Also required for on-site calibration of flow meters is the plant's ability to quickly supply large volumes of clean water to the calibrating expert. The flow meter calibration process typically demands up to 250 gallons of clean water. Upon arrival at the plant, the ordinary calibration expert requests access to a water supply, which may or may not be conveniently located, and spends a great deal of paid time at the plant's expense, waiting for a tank to be filled.

This water is passed through the flow meter in question during the calibration process. While calibration experts require manufacturing facilities to clean fluid flow meters prior to submitting them for calibration, fluid flow meters in use at chemical plants may contain trace amounts of contamination even after being rinsed, and the water used for calibration may easily become contaminated itself. In fact, in some instances, calibration experts have noticed contamination and have reported water that “comes out a different color” after it has passed through flow meters during calibration. Whenever serious fluid contamination becomes evident, properly maintained facilities are quick to shut down the calibration process, even if temporarily, to mitigate damages and implement protocols appropriate for the proper disposal of hazardous waste.

Calibration experts are aware that a meter under test, even when properly cleaned prior to submission, could on any given day contain ruptured parts or internal damage and that the mechanisms inside the meter may at any time retain contaminated fluids. For this reason, calibration experts treat all units under test as if containing trace amounts of hazardous waste and, in turn, handle all water used during meter calibration as though potentially contaminated.

Although theoretically clean, this potentially contaminated water is used for the calibration of multiple fluid flow meters in a single day. The possibilities of cross-contamination into separate components of the manufacturing process—components originally intended to remain isolated from one anotherare easily introduced. Experienced calibration experts readily acknowledge that the water, having passed through all kinds of meters during a long day of calibration services, can no longer be treated as clean and that no single meter tested that day can be considered immune from some form of cross-contamination.

Existing Methods for on-site flow meter calibration present clear and compelling quality-control issues for manufacturing facilities, chemical plants and other fluid-based industries.

Existing Methods: Disposal of Potentially Hazardous Waste into the Environment

Additionally, at the end of the calibration process, this 250-gallon tank of water lies in anticipation of disposal. Without being portable, the majority of these tanks of water are simply drained on-site and, under Existing Methods, water used in the flow meter calibration process is typically dumped onto the plant's outdoor property or into a common drainage system. In this way, potentially contaminated water is commonly allowed to enter into the local community water system or into the local environment.

Under Existing Methods, therefore, on-site flow meter calibration experts not only tap into a plant's time and resources during water-tank set-up procedures but also introduce the possibilities of both cross-contamination among fluid flow meters and the release of potentially hazardous waste into the environment.

While Existing Methods for flow meter verification and calibration include calibration procedures that match industry standards, it has become clear both to the calibration expert and to the manufacturing facility that improved methods for fluid flow meter calibration are needed. More specifically, plant managers and calibration experts alike wait in anticipation of calibration techniques that are safer, more convenient, less costly and more conscious of environmental protection.

### DETAILED DESCRIPTION OF THE INVENTION

The present invention employs the comparison of fluid flow meters to standardized Master Meters using the dynamic start-stop reference-meter method as described in —ISO 10790:1999 (E) and as described in other standards relating to the calibration of fluid flow meters.

This invention proposes a novel configuration of fluid flow meter calibration equipment, providing a combination of solutions to the problems inherent in Existing Methods for fluid flow meter calibration and creating a process for calibrating fluid flow meters that is safe, less invasive, more convenient, more cost-effective, faster and more environmentally friendly.

### DETAILED DESCRIPTION OF THE DRAWINGS

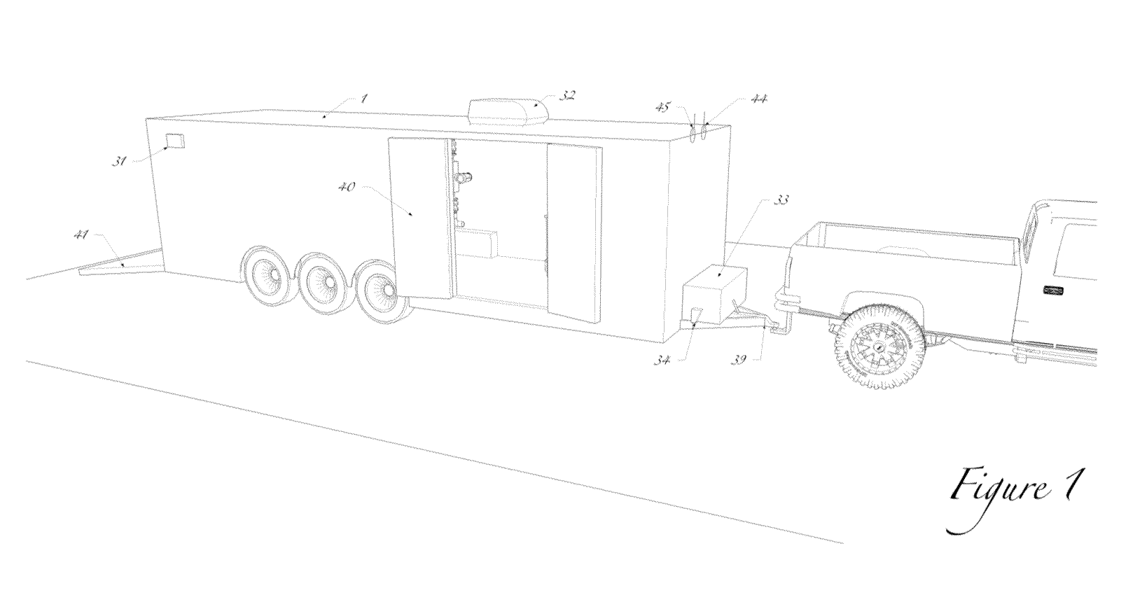

FIG. 1 depicts a sample configuration of the invention's exterior components.

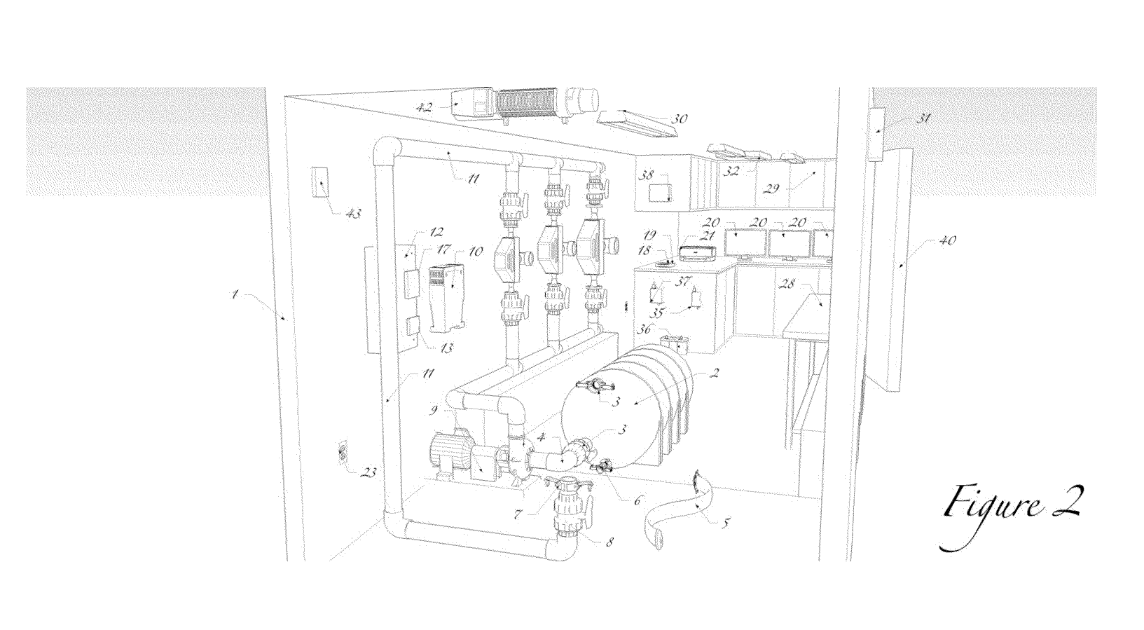

FIG. 2 depicts a sample configuration of the invention's interior components, as seen from the rear access point.

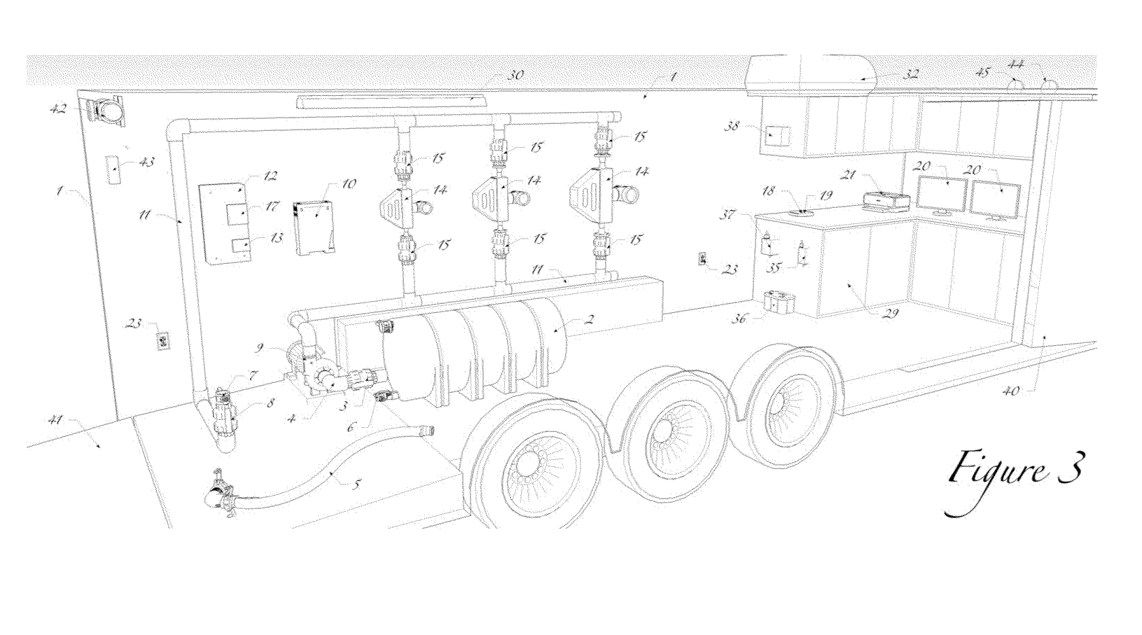

FIG. 3 depicts a sample configuration of the invention's interior components, as seen from a right-wall cut-out.

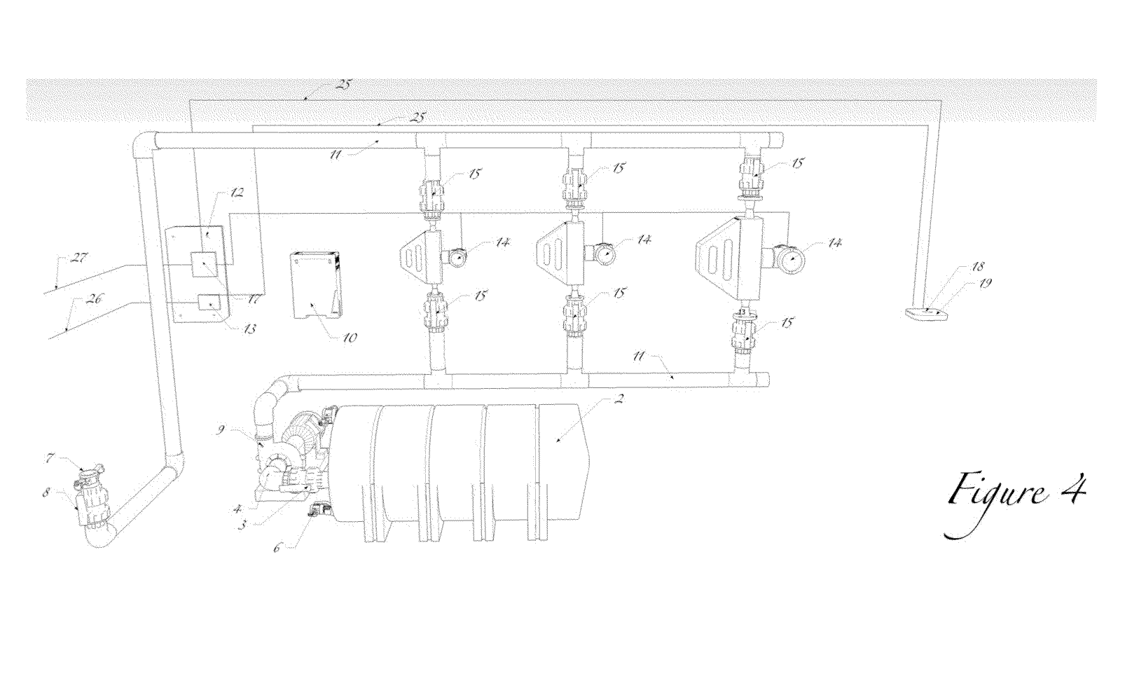

FIG. 4 depicts the specifications for an example arrangement of the invention's meter signal wires and meter communication wires.

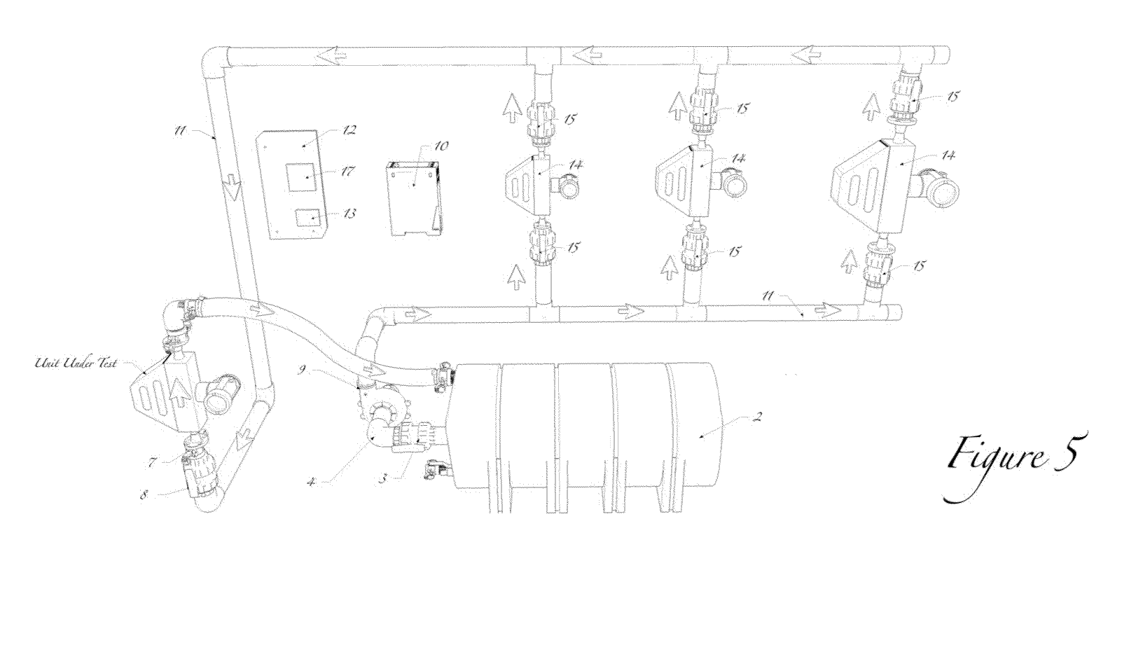

FIG. 5 depicts the direction of fluid flow inside a sample configuration of the invention's components.

The present invention significantly modifies existing calibration methods, processes, systems and equipment by introducing the portability of those systems in combination with an enclosed trailer, powered vehicle or other method of conveyance (1) containing a water tank (2) or a plurality of water reservoirs or tanks fitted with connections (3) for water pump suction pipes (4), return water lines (5) and drain valves (6) for the ultimate disposal of potentially contaminated water or hazardous waste.

The invention includes coupling adapters (7), which receive the Unit Under Test (UUT). These coupling adapters (7) are equipped with shut-off valves (8). Water pumps (9) and speed controllers or variable frequency drives (10) control fluid flow to the Unit Under Test, and return water lines (5) provide a pathway from the Unit Under Test back to the water reservoir. Included in the invention are pipes and/or pipe connections (11), allowing water or other fluids to flow safely between components.

Meter signal connection panels (12) are used to read the data coming from the fluid flow meters, while a plurality of meter configuration modems (13) assist in making adjustments to each meter's internal factors during calibration. For the sake of comparison to standardized meters, the invention is equipped with an array of NIST Traceable Master Meters (14) with meter array diversion valves (15). Master Meter communication wires (16) connect Master Meters (14) to meter signal connection panels (12) and, in turn, to an array of data acquisition devices (17), while computer systems (18) run fluid flow meter calibration and verification software (19) and fluid property analysis software (19). Computer monitors (20) and other peripheral components of the computer system such as printers (21) are necessary to assist in the analysis and reporting of fluid flow rate data.

The entire system is configured with wiring that includes main power lines (22) from the generator, uninterrupted power supply (UPS) electrical wiring and outlets (23), standard electrical wires (24), Universal Serial Bus (USB) cables (25), configuration modem wires (26), UUT communication wires (27) and Master Meter communication wires (16).

A combination of work benches, tables and stools (28), cabinetry (29), indoor lighting (30), outdoor lighting (31) and ventilated climate-control systems (32) such as air conditioning or heat together provide for efficiency, comfort and safety during the calibration process.

The components of this invention may be powered by a plurality of generators (33), a means of attaching (34) and/or securing generators to the trailer or conveyance (1), battery chargers (35), and batteries (36). Power inverters (37) and power distribution panels (38) convert and deliver electrical power.

A hitch (39) may be attached to the trailer (1) or to any form of conveyance capable of transporting calibration equipment to and from a facility. Doors (40) and/or sliding panels allow access to the climate-controlled work environment. A fold-down ramp (41) allows a fork lift or other equipment to import the Unit Under Test. A winch (42) and a winch hand controller (43) are attached to the trailer for the purpose of lifting into position the Unit Under Test.

Optional long-range wireless internet receivers (44) and cell phone signal repeaters (45) may be attached to the trailer, powered vehicle or method of conveyance (1).

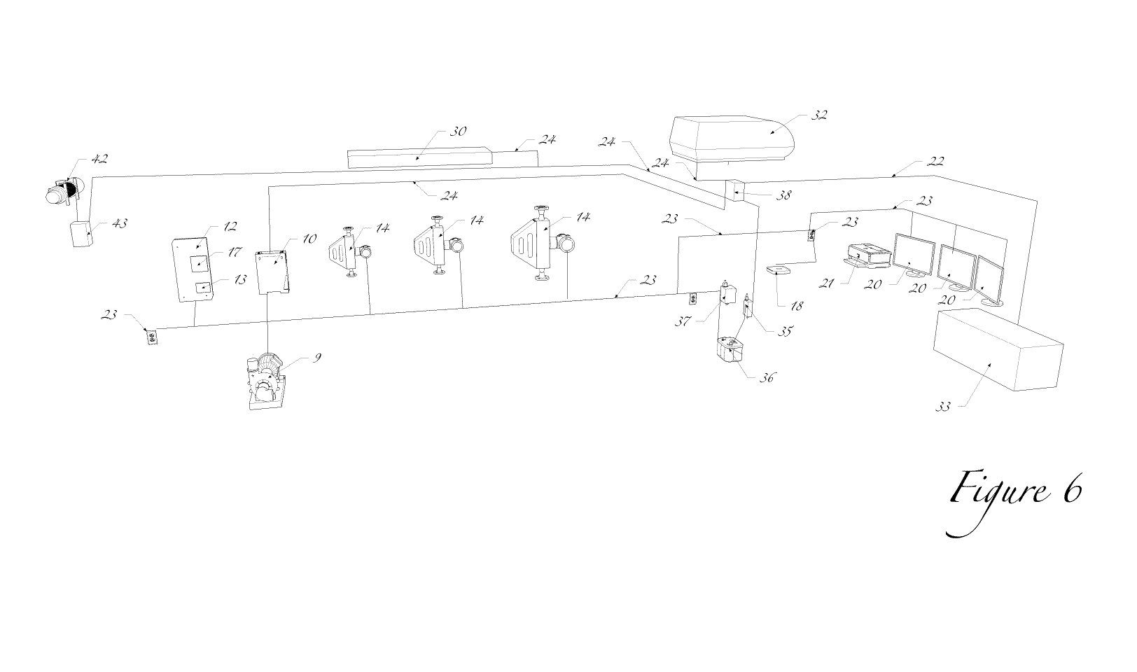

FIG. 6 depicts the specifications for one example arrangement of electrical wiring inside the invention.

The generator (33) supplies power to the invention's components through the main power lines (22). The main power lines are connected to the power distribution panel (38), which distributes standard electrical power to all non-calibration devices such as the air conditioner or heating system (32), the lighting (30), the winch (42), the winch controller (43), the water pump (9) and the battery charger (35).

The battery charger (35) then uses electrical power to charge the battery (36), which supplies electrical power to a pure-sine-wave power inverter (37). The electrical power delivered by the power inverter is no longer reliant on either the generator (33) or on the external grounding of the trailer (1) but allows the associated calibration equipment to run on a reliable and isolated electrical system.

Together, the power inverter (37) and the battery (36) create an uninterrupted electrical power supply (UPS) to all devices associated with sensitive calibration measurements, such as the Master Meters (14), Units Under Test (UUT), meter connection panels (12), meter configuration modems (13), data acquisition devices (17), computers (18), computer monitors (20), and all peripheral computer components (21).

This uninterrupted electrical power supply (UPS) allows for uninterrupted performance of computer systems (18, 19, 20, and 21) and of all calibration equipment, even when an interruption to electrical power occurs at the generator.

Additionally, a pure and uninterrupted supply of electrical power is significant in that highly sensitive calibration equipment is easily affected by electrical “noise” coming from generators and main power lines and may be influenced by the trailer's or the housing's own electrical grounding capacities.

### The Procedure

The present invention is brought by the calibrating technician to any chemical plant, manufacturing facility or other industry where fluid flow meters are in need of on-site calibration. The flow meter to be tested, also known as the “Unit Under Test” (UUT), is escorted up the ramp and enters into the invention's trailer or work space. The UUT is lifted into position by the winch and is connected to the UUT coupling adapter, which allows water to flow from the water pump into the UUT. The return water line allows water to flow from the UUT back into the water tank or reservoir.

The signal wire from the meter connection panel is then connected to the UUT's signal output while the meter configuration modem is connected to the UUT's signal input. The appropriate Master Meter valve or valves are opened to allow fluid flow through the calibration loop. The water pump is turned on and set to the appropriate flow rate for testing, as prescribed by the manufacturer of each UUT.

As water travels through the calibration loop, computer software reads flow rate data coming from the UUT and compares that data to the Master Meter's standardized measurements. Computer software calculates and reports the UUT's flow rate measurement error at this stage, prior to calibration. The water pump's speed controller is then adjusted and the same procedure for calculating and reporting the flow rate measurement error of a UUT is repeated for varying flow rates. The calibrating expert then uses the computer software and hardware to generate and print an “as-found” certificate for each UUT.

After this initial flow rate measurement evaluation process, a separate software program accesses the UUT's internal meter factors through a meter configuration modem and makes necessary adjustments to the internal meter factors. Adjustments are made until fluid flow rates inside the UUT are measured accurately as compared to NIST-traceable Master Meters, within the limits of error allowed by the manufacturer of the UUT.

The meter's ability to accurately measure fluid flow rates is then re-tested by comparison to the measurement of flow rates by the corresponding Master Meters, and an “as-left” certificate is generated by the calibrating technician.

The water pump is then turned off and the UUT shut-off valve closed. All meter diversion valves are closed. The return water line and the communication wires coming from both the meter connection panel and the meter configuration modem are disconnected from the UUT. The UUT is disconnected from the coupling adapter, lifted by the winch out of position and lowered onto the ramp for pick-up by the plant or facility.

The entire process of evaluating, calibrating and verifying the fluid flow rate measurement capabilities of a fluid flow meter takes less than an hour and often can be completed in approximately 30 minutes.

Should the fluid property analysis software and contamination alerting system determine that a fluid flow meter has brought a contaminant into the calibration loop, the calibrating technician would stop the calibration process by turning off the water pump and cutting off all meter array diversion valves and shut-off valves. The technician would immediately refer to the particular meter's decontamination form, provided by the facility prior to the calibration procedure, to determine the identity of the possible contaminants. The technician would then notify plant personnel about the event in question, and plant personnel would, if necessary, provide personal protective equipment (PPE) during disengagement of the UUT from the unit's coupling adapter.

The calibrating technician would then obtain from the facility a Material Safety Data Sheet (MSDS), which would be completed based on the identity of the contaminants or hazardous waste. With the MSDS in hand, the calibrating technician under the present invention would be able to quickly and safely transport the contaminated water to a site authorized for the disposal of hazardous waste. There, the technician would hand to authorities the completed MSDS and would follow regulated procedures for the disposal of contaminated water. During disposal, the technician would open all valves, including meter diversion valves, drain valves and shut-off valves, and would completely drain whatever calibration loops had previously become contaminated.

The technician would then obtain from the hazardous waste disposal site a fresh water supply or a cleaning agent, as prescribed by the Material Safety Data Sheet, and would “back flush” the entire calibration loop by introducing the cleansing solution through the coupling adapter, allowing it to flow in a reverse direction through the Master Meter array and water tank. The technician would allow the tank's drain valve to remain open during the back flush of the entire system.

In this way, hazardous waste generated during fluid flow meter calibration procedures may be removed from the calibrating work site and properly disposed of in a timely fashion. Should the site authorized to receive hazardous waste be within range of the manufacturing facility, calibrations of fluid flow meters back at the work site can be resumed within a few hours of any interruptions due to contamination while no contaminated waste is ever allowed to enter into the local community's water supply or drainage system. Likewise, should the calibrating technician choose to carry on-board the invention more than one water tank, as described herein, on-site calibrations may continue without any interruption, even in cases of unexpected contamination and subsequent isolation of one or more water tanks.

### The Procedure in Reference to the Drawings

The present invention is brought by the calibrating technician to any chemical plant, manufacturing facility or other industry where fluid flow meters are in need of on-site calibration. The flow meter to be tested, also known as the “Unit Under Test” (UUT), is escorted up the ramp (41) and enters into the invention's trailer or work space (1). The UUT is lifted into position by the winch (42) and is connected to the UUT coupling adapter (7), which allows water to flow from the water pump (9) into the UUT. The return water line (5) allows water to flow from the UUT back into the water tank or reservoir (2).

The signal wire (27) from the meter connection panel (12) is then connected to the UUT's signal output while the meter configuration modem (13) is connected to the UUT's signal input by way of configuration modem wires (26). The appropriate Master Meter valve or valves (15) are opened to allow fluid flow through the calibration loop. The water pump (9) is turned on and set to the appropriate flow rate for testing, as prescribed by the manufacturer of each UUT.

As water travels through the calibration loop, computer software (19) reads flow rate data coming from the UUT and compares that data to the Master Meter's standardized measurements. Computer software calculates and reports the UUT's flow rate measurement error at this stage, prior to calibration. The water pump's speed controller (10) is then adjusted and the same procedure for calculating and reporting the flow rate measurement error of a UUT is repeated for varying flow rates. The calibrating expert then uses the computer software and hardware (21) to generate and print an “as-found” certificate for each UUT.

After this initial flow rate measurement evaluation process, a separate software program accesses the UUT's internal meter factors through a meter configuration modem (13) and makes necessary adjustments to the internal meter factors. Adjustments are made until fluid flow rates inside the UUT are measured accurately as compared to NIST-traceable Master Meters (14), within the limits of error allowed by the manufacturer of the UUT.

The meter's ability to accurately measure fluid flow rates is then re-tested by comparison to the measurement of flow rates by the corresponding Master Meters, and an “as-left” certificate is generated by the calibrating technician.

The water pump (9) is then turned off and the UUT shut-off valve (8) closed. All meter diversion valves (15) are closed. The return water line (5) and the communication wires (26, 27) coming from both the meter connection panel (12) and the meter configuration modem (13) are disconnected from the UUT. The UUT is disconnected from the coupling adapter (7), lifted by the winch (42) out of position and lowered onto the ramp (41) for pick-up by the plant or facility.

The entire process of evaluating, calibrating and verifying the fluid flow rate measurement capabilities of a fluid flow meter takes less than an hour and often can be completed in approximately 30 minutes.

Should the fluid property analysis software (19) and contamination alerting system (19) determine that a fluid flow meter has brought a contaminant into the calibration loop, the calibrating technician would stop the calibration process by turning off the water pump (9) and cutting off all meter array diversion valves (15) and shut-off valves (8). The technician would immediately refer to the particular meter's decontamination form, provided by the facility prior to the calibration procedure, to determine the identity of the possible contaminants. The technician would then notify plant personnel about the event in question, and plant personnel would, if necessary, provide personal protective equipment (PPE) during disengagement of the UUT from the unit's coupling adapter (7).

The calibrating technician would then obtain from the facility a Material Safety Data Sheet (MSDS), which would be completed based on the identity of the contaminants or hazardous waste. With the MSDS in hand, the calibrating technician under the present invention would be able to quickly and safely transport the contaminated water to a site authorized for the disposal of hazardous waste. There, the technician would hand to authorities the completed MSDS and would follow regulated procedures for the disposal of contaminated water. During disposal, the technician would open all valves, including meter diversion valves (15), drain valves (6) and shut-off valves (8), and would completely drain whatever calibration loops had previously become contaminated.

The technician would then obtain from the hazardous waste disposal site a fresh water supply or a cleaning agent, as prescribed by the Material Safety Data Sheet, and would “back flush” the entire calibration loop by introducing the cleansing solution through the coupling adapter (7), allowing it to flow in a reverse direction through the Master Meter array (14) and water tank (2). The technician would allow the tank's drain valve (6) to remain open during the back flush of the entire system.

In this way, hazardous waste generated during fluid flow meter calibration procedures may be removed from the calibrating work site and properly disposed of in a timely fashion. Should the site authorized to receive hazardous waste be within range of the manufacturing facility, calibrations of fluid flow meters back at the work site can be resumed within a few hours of any interruptions due to contamination while no contaminated waste is ever allowed to enter into the local community's water supply or drainage system. Likewise, should the calibrating technician choose to carry on-board the invention more than one water tank (2), as described herein, on-site calibrations may continue without any interruption, even in cases of unexpected contamination and subsequent isolation of one or more water tanks (2).

### The Present Invention: Solutions to Existing Problems

### Quick Set-Up Times, Convenience to the Customer and Increased Productivity

The present invention introduces a portable fluid flow meter calibration system. Because the complete line of calibration equipment arrives on-site ready to perform service, manufacturing plants avoid the cost and risk of shipping expensive and delicate fluid flow meters to off-site calibration facilities. In this way, although disengagement from the line of production is still required, fluid flow meters may be completely and accurately calibrated on-site in less than an hour rather than being removed from the line of production for weeks at a time.

Additionally, because the current invention includes one or more clean, pre-filled water tanks, calibration of fluid flow meters requiring large volumes of water may begin within moments of the expert's arrival at a facility under the current invention. The need to fill large tanks of water on-site is averted and the manufacturing plant avoids a 3-hour waiting period while a calibrating expert sets up. Under the present invention, therefore, manufacturing facilities are able to re-coup time otherwise lost during the traditional calibrating expert's setup and tear-down of large water tanks and other important calibration equipment.

Fluid flow meters are also used at plants such as nuclear power facilities where access to third-party vendors is highly restricted for security and safety reasons alike. Because the current invention provides for the verification and calibration of fluid flow meters in portable trailers, the calibration and verification of fluid flow meters may be conducted in non-restricted, non-process areas nearby, and the need for security clearance can be waived while flow meter calibrations are speedily completed.

### Enhanced Occupational Safety

The present invention offers unprecedented levels of occupational safety to the calibrating technician and, in turn, to the plant or manufacturing facility in need of service. Calibrations completed several yards away from process areas or in true non-process areas such as parking lots allow for fluid flow meter calibration with little to no risk to the calibrating technician who rarely, if ever, enters into areas reporting hazardous materials.

Because under the present invention the calibrating expert works outside of process areas and therefore away from any traces of explosive gases, both calibrating technicians and plant managers alike can may complete the calibration and verification processes without assuming the risks assumed by personnel who turn on potentially spark-producing equipment such as computers and other electronics in process areas where traces of explosive gases may linger.

The present invention also provides to the calibrating technician a ramp for the import of fluid flow meters—often weighing up to 200 pounds—and a winch with a winch hand controller for the purpose of lifting the meters into position prior to calibration. Manufacturing plants, chemical refineries and other facilities where fluid flow meters are calibrated can, with the present invention, gain reputations in the community as notably safer work environments.

Sufficient Levels of Electrical Current, Large-Diameter Flow Meter Calibration, and Noninterference with Plant Functions or Power Supplies

The present invention provides an encapsulated power supply and in no way demands electrical power or connections to electrical power from the manufacturing facility. The manufacturing facility is relieved of the responsibility to provide not only sufficient electrical current but also the “Hot Work Permit” traditionally required when any third party attempts to plug third-party equipment into electrical power supplies on-site. Electrical wiring need not be upgraded to accommodate the visiting calibration expert and plant managers need not spend valuable time providing electrical power or other plant resources to the calibrating expert.

Under the present invention, the calibrating expert arrives on-site with electrical power sufficient to create the high fluid flow rates needed for the calibration of larger flow meters. In this manner, the calibrating expert is not limited to calibrating small-diameter fluid flow meters but can easily calibrate flow meters with large diameters. In this way, the plant or facility is provided the convenience of a “one-stop shop” for all flow meter calibrations on the same day.

The combination of the generator and power inverter in unison with the battery charger and battery provides to the calibrating expert a steady, controllable and reliable source of electrical power. Plant managers can toss aside former concerns about flow-meter calibrations causing facility breakers to “trip” or about temporary interruptions to plant productivity while the calibrating expert's equipment makes unusual demands on the plant's electrical current.

Prevention of Cross-Contamination among Flow Meters

Because the present invention arrives on-site with one or more portable, self-contained tanks of clean water, at no time does the plant's own productivity become interrupted—even if a fluid flow meter under test proves to be contaminated or introduces contamination into the tank.

The portability of the water tanks needed for fluid flow meter calibration under the present invention translates into the speedy removal of contaminated waste. Likewise, the presence of “spare” on-board water reservoirs translates into the flexibility of being able to continue calibrating multiple flow meters using fresh, clean water—even after contamination occurs in one tank.

The presence of water tanks on board, together with several arrays of Master Meters and other equipment, may alternatively be employed in such a way that cross-contamination of species in fluid flow meters is avoided almost entirely. While acidic fluids should not mingle together with proteins, sugars, caustic fluids or petroleum products, the calibrating expert can use the present invention to keep different categories of fluids in fluid flow meters completely separate as they are calibrated using separate waterlines, separate water supplies, separate Master Meters and separate diversion valves.

### Authorized and Safe Disposal of Hazardous Waste

While Existing Methods resort to local community drainage systems for the on-site disposal of water used during flow meter calibration, the present inventors are aware of the need to treat potentially contaminated water as hazardous waste and to refrain from dumping such contaminated water into community water supplies.

As a result of this awareness, the present invention is designed to easily and quickly transport potentially contaminated water off-site to a location authorized to accept hazardous materials.

The present invention may accommodate software capable of analyzing fluid density and other fluid properties in order to verify contamination levels in the water being used. Through the use of such fluid property testing, the present invention can not only interrupt calibration processes associated with a contaminated tank of water but can also “tag” that water in its isolated tank for appropriate disposal as hazardous waste.

Using this method, the calibrating expert makes note of the species of fluid assigned to each fluid flow meter under test and, should the water used for testing become contaminated, the calibrating expert using the current invention may complete a Material Safety Data Sheet (MSDS) on any particular contaminant. Without interrupting the series of calibrations on-site, the calibrating expert can at the end of the day deliver both contaminated water and the corresponding Safety Data Sheets to local waste management centers for the sake of authorized disposal.

### PRIOR ART

Although many patented processes and combinations of equipment provide for accurate calibration and verification of fluid flow meters, no existing configurations fully resolve the following problems:
1. Interruptions to productivity while the unit under test is moved off-site or while an on-site calibrating expert uses the facility's time and resources for on-site equipment setup
2. Limits on the sizes of fluid flow meters that can be calibrated on-site due to limited on-site electrical current and, in turn, limited fluid flow rates obtained during calibration
3. Concerns about quality control and cross-contamination among fluid flow meters used in separate divisions of manufacturing
4. Improper disposal of hazardous and/or potentially contaminated waste water

For example, U.S. Pat. No. 636,0579 B1 explains in detail the importance of accurate calibration methods and introduces a “statistical optimization technique” by proposing that two flow meter arrays be used in conjunction with one another for the sake of reducing levels of uncertainty. Although the components of this system are “modular” and may be disassembled, this configuration is not designed to be used on-site at a manufacturing facility and is not designed to be portable on a daily basis. This invention's configuration is, in fact, the configuration used currently for off-site calibrations, requiring that a fluid flow meter under test be removed from the line of production and shipped to a calibration outpost. As previously noted, this “down time” can last for weeks as the unit is removed from the line of production and subjected to the risks of long-distance shipping.

Similarly, U.S. Pat. No. 7,447,137 B2, addresses concerns about cross-contamination among fluid flow meters during on-site calibration and proposes that a fresh supply of water be used at each on-site calibration for the sake of avoiding such cross-contamination. However, while this method goes far in protecting the flow meters themselves from contamination, the proposal fails to mention any urgency in protecting the environment and, in fact, calls for a connection to an existing “drain pipe,” indicating that the very waste that would be considered contaminating to the meters should be directed into a standard drainage system and released into groundwater. In this way, the process cares for the integrity of the manufacturing facility without caring for the integrity of its surroundings.

This same method fails to address the high cost of set-up time at the facility as water tanks are filled and later emptied. Issues of inconvenience and decreased productivity remain unchallenged by this proposed method of on-site flow meter calibration.

This method also employs the use of the facility's electrical current and water supply. As previously noted, electrical current and voltage available at the typical facility translates into a power supply of up to 2,400 Watts—a level insufficient for the purpose of calibrating fluid flow meters with diameters greater than 2 inches. U.S. Pat. No. 7,441,437 B2 suggests no solution for larger fluid flow meters or calibrations that require levels of electrical current not typically available on-site.

And finally, the invention described by U.S. Pat. No. 7,441,437 B2 makes no mention of a winch or other system for lifting the units under test into position. Fluid flow meters tested on-site can weigh up to 200 pounds. Because U.S. Pat. No. 7,441,437 B2 includes no provision for the lifting and/or transfer of fluid flow meters from their position in the factory's line of production to the calibrating expert's work location, this invention fails to address the obvious strain placed on the calibrating technician or on company personnel as they attempt to transfer the delicate yet cumbersome fluid flow meters.

The present inventor would also like to draw attention to Publication No. DE20316032 U1, which represents the arrangement and sequence of equipment used widely during fluid flow meter calibration, both on-site and off-site. The scope of this arrangement is limited, however, and represents a stark contrast to the present invention in the following ways:
(1) The ability to make adjustments and/or corrections to the measurement of fluid flow rates inside fluid flow meters is integral to the calibration of those meters. Publication No. DE20316032 U1 makes no claim to the inclusion of meter configuration modems or any other means of correcting and/or adjusting the measurement of fluid flow rates inside meters under calibration. In fact, despite the use of the word calibration in the publication's title, no viable method for the adjustment of flow-rate data collection is discussed within the publication's specifications. The system referenced provides for the verification of fluid flow rates through fluid flow meters and “is equipped with the appropriate evaluation of software to visualize and record the measurement results” (Description, paragraph 14) but omits both the hardware and the software required to manipulate the measurement of those rates during calibration. In this way, the arrangements represented by Publication No. DE20316032 U1 limit the service professional to the measurement and verification of fluid flow rates. Faulty meters cannot be corrected under this arrangement. In contrast, any expert employing the current invention's system, method and apparatus will be able to offer both the verification and the standardized, accurate calibration of a meter's fluid flow rate measurements.
(2) The arrangement cited in Publication No. DE20316032 U1 requires that the fluid flow meter under test be attached to an existing tank or reservoir of fluid. For example, the referenced invention describes a tanker vehicle with a fluid flow meter as an extension of the tanker's fluid reservoir (claim 1.4). Although a tanker's fluid reservoir is typically transportable, the invention in claim 1 mentions the testing of a “reservoir flow meter” and assumes that the data-collecting apparatus arrive separately and connect to a fluid flow meter-fluid reservoir combination. The example depicted is a type of tanker vehicle that makes use of a built-in fluid flow meter while dispensing its load, but any other “tested flowmeter is involved, has regularly on almost every reservoir” (see Description, paragraph 11) indicates that the flow meter under test will be found as part of the normal dispensing apparatus on an existing fluid reservoir.
Reservoirs are indeed required during the calibration process, but the referenced patent relies on the customer to provide that reservoir in conjunction with the meter under test. Because of this expressed “reservoir flow meter” limitation, Publication No. DE20316032 U1 would not be equipped to arrive on-site at manufacturing facilities where free-standing fluid flow meters are not attached or connected to reservoirs designated for the calibration process.
In contrast, the present applicant's invention provides to the client one or more fluid reservoirs for the purpose of flow meter verification and calibration and arrives on-site with those reservoirs as components of the calibrating apparatus itself. The manufacturing facility, therefore, enjoys the freedom of providing to the calibrating expert fluid flow meters that are not attached to fluid reservoirs.
(3) Because Publication No. DE20316032 U1 describes the verification of fluid flow meters attached to fluid reservoirs such as tanker vehicles or stationary fluid reservoirs, the Master Meters used in this arrangement are by definition subjected to the fluids contained in those reservoirs. As such, in this referenced system, clean water would not typically be the fluid used for the calibration process, and clean water would not be the fluid passing through the standardized Master Meters during verification or calibration. Instead, fluids typically and/or potentially containing debris and entrained air bubbles pass through the calibration loop under Publication No, DE20316032 U1. Accurate flow rate data collection is therefore potentially compromised, and contamination not only of Master Meters but also of future meters under test becomes an immediate concern. The invention provides no means of preventing Master Meter contamination, nor does it mention any relief from contamination or any means of decontamination for the Master Meter once the Master Meter's service to that tanker is complete.
In contrast, the invention under application makes use of clean water circulating through a closed loop during the calibration process and ensures that accurate flow rate data collection is maintained without any interference from particles, floating debris or entrained air.
Should contaminants ever be introduced into the calibration loop, the invention under application includes an alarm system with instant contaminant notifications.
Additionally, because of its self-contained and portable reservoir-calibration loop combination, the present invention protects Master Meters and tested fluid flow meters alike by allowing for the efficient disposal of contaminated water and/or replacement of clean water reservoirs.
   (4) While tanker vehicles and the attached fluid flow meters under test are mentioned as portable in Publication No. DE20313032 U1, the components used for the measurement and verification of fluid flow rates in this arrangement are not themselves housed in any form of trailer, vehicle or mode of transportation. As a result, these components must require some form of assembly on-site, particularly as they attach to the fluid reservoir as part of the “reservoir flow meter” under test. Specifically, the Claims specify that the fluid “return line opens into the space above the liquid level within the tank container” (claim 1.6). Because stationary fluid reservoirs at chemical plants or manufacturing facilities and on tanker vehicles alike are large, the attachment of the return line to a space above the liquid level within the reservoir may prove to be challenging and require a great deal of time and effort as massive flow lines are manipulated and connected to existing or non-existing ports atop such reservoirs. Meanwhile, on the ground, assembly of Master Meters and computer systems must also be managed within range of the “reservoir flow meter” under test. Assembly of the apparatus, therefore, remains a disadvantage to both expert and customer.
In contrast, the invention under application allows for the calibrating expert to arrive on-site with a completely set-up, self-contained calibrating system that requires no assembly, and accurate flow meter calibrations may begin within moments of the expert's arrival.
(5) Additionally, because under Publication No. DE20313032 U1 the components used for the measurement and verification of fluid flow rates are not themselves housed in any form of trailer, vehicle or mode of transportation, components such as computer systems, Master Meters and delicate circuitry are without protection and are exposed to elements such as wind, rain, lightning, snow, fog, and extreme temperatures, particularly where meters under test are part of an outdoor “stationary tank installation” (claim 1.5) on-site at a manufacturing facility or chemical refinery.
In contrast, the invention under application includes a climate-controlled trailer or vehicle and therefore provides for the housing and protection of a pre-assembled, safely transportable calibration system. The physical components of the calibration system and the calibrating expert himself or herself are altogether protected in a comfortable and safe work environment.
(6) Under Publication No. DE20316032 U1, when the verifying expert arrives on-site with intent to connect his or her data collection apparatus to a tanker vehicle or stationary fluid reservoir, the expert introduces electrical circuitry into an area where potentially flammable liquids and gases are stored. As such, the calibrating technician adopting safe calibration techniques requires that the customer—the owner of the fluid flow meter and tanker or reservoir—provide a “Hot Work Permit” and certify that no flammable gases have been detected in the immediate area. This permit ensures that the calibrating expert may safely attach electronic devices to the fluid flow meter.
Because fluid flow meters attached to tanker vehicles are, by definition, attached to volatile liquid reservoirs, such Hot Work Permits under the arrangements described in Publication No. DE20316032 UI would prove nearly impossible to obtain. In fact, in paragraph 10 of the invention's Description, the arrangements cited claim to be “especially suitable for this reason, processes for the calibration of measuring pressure liquefied gases, hydrocarbons, and other similar fluids.” The fluids cited in this publication, therefore, are the very fluids that would prohibit the issuance of the typical facility's Hot Work Permit and thereby prevent the initiation of electronically controlled calibration procedures.
Even under rare circumstances when the tanker vehicles being serviced are carrying non-flammable fluids, the arrangement in Publication No. DE20316032 U1 passes along to the owner of the fluid flow meter the inconvenience of obtaining the Hot Work Permit and may at times tempt the service professional to side-step this Hot Work Permit requirement when tanker vehicles are in need of service along distant routes.
In contrast, the invention under application uses a clean-water loop during calibration and never requires the introduction of flammable liquids. Additionally, because the meters under test are brought into a portable, self-contained and controlled environment, an environment maintained by the calibrating expert and not managed by the owner of the fluid flow meter, manufacturing facilities are relieved of the responsibility to provide Hot Work Permits when calibrating experts choose to employ the present invention.
This ease of access and instant initiation of safe calibrating procedures translates into savings of both time and money for the fluid flow meter customer.
(7) The invention described in Publication No. DE20316032 U1 makes use of a type of fluid pump, or the “means . . . included to promote good” (claim 1-3), which “can be associated with the use of the reservoir discharge pump” (see Description, paragraph 12). While fluid pumps are required for the verification and calibration of fluid flow meters, Publication No. DE20316032 U1, makes no mention of any form of speed controller for the pump in use during verification. Reservoir discharge pumps associated with typical tanker vehicles and large, stationary fluid reservoirs rarely, if ever, contain fluid flow speed controllers, and pumps attached to tanker vehicles and large, stationary fluid reservoirs are not the kind of pumps powerful enough to attain the higher fluid flow rates required for accurate flow meter calibration.
Fluid flow meters of larger diameters require higher fluid flow rates during the calibration process. The invention referenced in Publication No. DE20316032 U1 makes no allowance for any type of fluid flow speed control.
In this way, Publication No. DE20316032U1 not only fails to comply with the procedures set out in ISO 10790:1999 for including a method of controlling fluid flow rates through meters of varying diameters but also demonstrates a lack of capability in terms of reaching optimum flow meter calibration rates as prescribed by any instrument's manufacturer.
In contrast, the present invention incorporates speed controllers alongside every fluid pump and therefore provides for the fast and accurate calibration of any diameter fluid flow meter and is fully equipped to achieve the exact fluid flow rates recommended by any meter's original manufacturer. In this way, the present invention is compliant with internationally approved procedures and standards for fluid flow meter calibration and verification.
(8) Publication No. DE20316032U1 makes no mention of any means of reporting fluid flow meter verification or calibration results, while the invention under application includes an arrangement of hardware and computer printers, designed to generate reports that may be delivered to the customer.
(9) And finally, Publication No. DE20316032 U1 does not provide for the safe transfer and/or positioning of Master Meters or other fluid flow meters, which often weigh up to 200 pounds, whereas the present invention offers not only a ramp for ease of access to all components of the invention but also a winch for the purpose of safely hoisting the heavy, cumbersome and highly sensitive fluid flow meters into position prior to service.

### PATENT CITATIONS

U.S. Pat. No. 476,095
U.S. Pat. No. 4,252,028
U.S. Pat. No. 6,360,579 B1
U.S. Pat. No. 7,441,437 B2
U.S. Pat. No. 6,475,135
U.S. Pat. No. 6,782,333
U.S. Pat. No. 7,028,528
Publication No. DE20316032U1
Publication No. WO2004036156A2
U.S. Pat. No. 899,960 A

### CLASSIFICATIONS

### U.S. Classification 73/1.35

### International Classification G01F25/00, G01F1/84

### Cooperative Classification G01F25/003

European Classification G01F25/00A6

1. A fluid flow meter calibration equipment system, method and arrangement, housed and protected by a portable trailer, powered vehicle or other method of conveyance and comprised of one or more gas and/or liquid tanks or reservoirs, used for the containment and/or transportation of fluids circulated during the calibration and/or verification of fluid flow instrumentation such as fluid flow meters, combined with a means of comparing non-standardized fluid flow instrumentation against standardized fluid flow instrumentation such as fluid flow Master Meters.

2. A portable, pre-assembled and self-contained fluid flow meter calibration equipment system, method and arrangement, housed and protected by a trailer, powered vehicle or other method of conveyance, including
(a) an on-board fluid reservoir, a means for connecting to a fluid reservoir, or a means of simulating fluid pressure,
(b) an on-board fluid pump, a means for connecting to a fluid pump or any other means of promoting fluids, or a means of simulating fluid flow,
(c) an on-board electrical power supply or a means for connecting to a wired and/or wireless external power supply,
(d) the primary components of a fluid flow meter calibration system such as Master Meters or other devices used as standards during fluid flow meter performance comparisons, meter connection panels or other devices capable of collecting fluid flow rate data from fluid flow meters, meter configuration modems or other devices capable of adjusting fluid flow meter measurement settings, meter signal communication wires and computer systems or other devices capable of interpreting fluid flow rate data, and
(e) a means for connecting fluid flow meters to the portable calibration equipment system,
such that the primary components of the calibration system may be transported in a pre-assembled fashion and such that fluid flow meters in need of calibration and/or verification, whether off-site or on-site, may be introduced into the portable system, connected to the calibrating equipment, and verified and/or calibrated without the typical delays and inconveniences normally brought on by the calibrating technician's assembly and/or disassembly of flow meter calibration equipment such as water pumps, water reservoirs, Master Meters, meter connection panels, meter configuration modems, and/or computer systems.

3. One or more water tanks or reservoirs in combination with a portable arrangement of equipment and systems designed for the purpose of fluid flow meter calibration and verification and housed by a trailer, powered vehicle or other method of conveyance, such that the fluids, waste water or hazardous materials used during the processes of calibration and/or verification of fluid flow meters may be safely contained, easily removed from process areas, and conveniently transported to sites authorized to receive and dispose of potentially contaminated water and hazardous waste.

4. The fluid flow meter calibration equipment system and arrangement set forth in claim 1 with a combination of one or more additional fluid reservoirs or tanks connected to or housed by the portable, pre-assembled system.

5. The fluid flow meter calibration equipment system and arrangement set forth in claim 1 with a means of separation between water reservoirs in order to avoid cross-contamination among flow meters during fluid flow meter verification and calibration.

6. The fluid flow meter calibration equipment system and arrangement set forth in claim 1 with a series of water pumps, water pump speed controllers, pipes, pipe connections, fluid flow diversion valves, shut-off valves, return water lines, and valves for the purpose of draining water, potentially contaminated water or hazardous waste from the reservoirs.

7. The fluid flow meter calibration equipment system and arrangement set forth in claim 1 with fluid flow meter coupling adapters, pipes, pipe connectors and hoses.

8. The fluid flow meter calibration equipment system and arrangement set forth in claim 1 with standardized Master Meters, meter signal connection panels, data acquisition devices, computer systems, meter configuration modems, configuration modem wires, USB cables, electrical wires, meter signal communication lines, and computer software designed for the purpose of verifying and calibrating fluid flow meters.

9. The fluid flow meter calibration equipment system and arrangement set forth in claim 1 with wired and/or wireless connections to and from computer terminals, wired and/or wireless connections to and from peripheral computerized devices, long-range wireless internet receivers and cell phone signal repeaters.

10. The fluid flow meter calibration equipment system and arrangement set forth in claim 1 with generators, battery chargers, batteries, power inverters, power distribution panels, electrical cables and wiring, electrical outlets, indoor and outdoor lighting, and climate control in the form of air conditioning, heating systems and/or humidification controls.

11. The fluid flow meter calibration equipment system and arrangement set forth in claim 1 with work benches, tables, stools, shelves, cabinetry and other surfaces necessary for the handling, calibration and verification of fluid flow meters.

12. The fluid flow meter calibration equipment system and arrangement set forth in claim 1 with a ramp, a winch, a winch hand controller and a hitch.

13. The fluid flow meter calibration equipment system and arrangement set forth in claim 1 with doors, windows and/or sliding panels.

14. The fluid flow meter calibration equipment system and arrangement set forth in claim 1 with the use of computer software capable of analyzing a variety of fluid properties such as fluid density and with the use of software-based fluid-property alerting devices and/or alarm indicators.

15. The fluid flow meter calibration equipment system and arrangement set forth in claim 1 with density meters, pH analyzers, dissolved oxygen analyzers, turbidity meters, chlorine analyzers and other fluid property meters and with one or more fluid property analyzers capable of sending signals to one or more meter connection panels.
